(19) United States
(12) Patent Application Publication
(10) Pub. No.: US 2015/0339183 A1
(43) Pub. Date: Nov. 26, 2015

(54) CONTROLLER, STORAGE DEVICE, AND CONTROL METHOD

(71) Applicant: KABUSHIKI KAISHA TOSHIBA, Tokyo (JP)

(72) Inventors: Hironori Nakanishi, Yokohama Kanagawa (JP); Kana Furuhashi, Kawasaki Kanagawa (JP)

(21) Appl. No.: 14/477,432

(22) Filed: Sep. 4, 2014

Related U.S. Application Data
(60) Provisional application No. 62/001,341, filed on May 21, 2014.

(51) Int. Cl. G06F 11/10

(52) U.S. Cl. CPC G06F 11/1004

(57) ABSTRACT

According to embodiments, a controller is provided with a receiving unit which receives data and a first redundant bit generated by coding the data by using a first generator polynomial, a coding unit which codes the data by using a second generator polynomial having a common factor with the first generator polynomial to generate a second redundant bit, and an error check unit which determines whether there is difference between the input data to coding by using the first generator polynomial and the input data to coding by using the second generator polynomial by dividing an XOR operation result of the first redundant bit and a result of a bit shift of the second redundant bit by the common factor.

### CROSS-REFERENCE TO RELATED APPLICATIONS

This application is based upon and claims the benefit of priority from U.S. Provisional Application No. 62/001,341, filed on May 21, 2014; the entire contents of which are incorporated herein by reference.

### FIELD

Embodiments relate to a controller, a storage device, and a control method.

### BACKGROUND

In the storage device using a magnetic disk, a semiconductor memory, and the like, data is encoded such that destroy of the data may be detected or corrected. The storage device includes a plurality of data paths such as a path from a host to a primary storage medium and a path from the primary storage medium to a non-volatile storage medium such as the magnetic disk. A plurality of storage media such as a static random access memory (SRAM) and a dynamic random access memory (DRAM) might be used as the primary storage medium. In this case, there also is a data path between the primary storage media.

A trend and a property of frequent errors differ depending on the data path, so that a unit of coding and a generator polynomial differ from one data path to another in general. Therefore, when the data is moved between the media, a protection system (unit of coding and generator polynomial) of the data might be changed. For example, suppose that a hard disk controller is provided with the DRAM and SRAM, stores the data received from the host in the SRAM, and stores the data read from the SRAM in the DRAM. In this case, the protection system to the data is changed from a first protection system to the data stored in the SRAM to a second protection system to the data stored in the DRAM during a process to store the data read from the SRAM in the DRAM.

### BRIEF DESCRIPTION OF THE DRAWINGS

FIG. 1 is a block diagram of a configuration example of a storage device according to a first embodiment;

FIG. 2 is a view of a configuration example of a controller of a comparative example in which circuit synthesis is performed;

FIG. 3 is a block diagram of a configuration example of a protection unit according to the first embodiment;

FIG. 4 is a view of a configuration example of a path protection unit of the first embodiment;

FIG. 5 is a view of an XOR of a result of shifting R_{B}(x) by m bits and R_{A}(x);

FIG. 6 is a flowchart of an example of a procedure in the path protection unit of the first embodiment;

FIG. 7 is a view of a configuration example of a unit conversion unit;

FIG. 8 is a view of an example of a unit conversion procedure when the unit conversion unit of the configuration example in FIG. 7 is used;

FIG. 9 is a block diagram of a configuration example of a unit conversion unit in a storage device according to a second embodiment; and

FIG. 10 is a view of an example of a unit conversion procedure when a bus width of protection A is different from that of protection B.

### DETAILED DESCRIPTION

A controller of the embodiments includes a receiving unit which receives data and a first redundant bit generated by coding (first coding) of the data by using a first generator polynomial, a first error check unit which compares a redundant bit generated by coding of the data by the first generator polynomial and the first redundant bit which is transmitted, a coding unit which codes (second coding) the data by a second generator polynomial having a common factor with the first generator polynomial to generate a second redundant bit. The controller further includes an error check unit which determines whether there is difference between the data input to the first coding and the data input to the second coding by dividing an XOR operation result of the first redundant bit which is received and a result of a bit shift of the second redundant bit by the common factor.

The controller, a storage device, and a control method according to the embodiments are hereinafter described in detail with reference to the attached drawings. Meanwhile, the present invention is not limited by the embodiments.

### First Embodiment

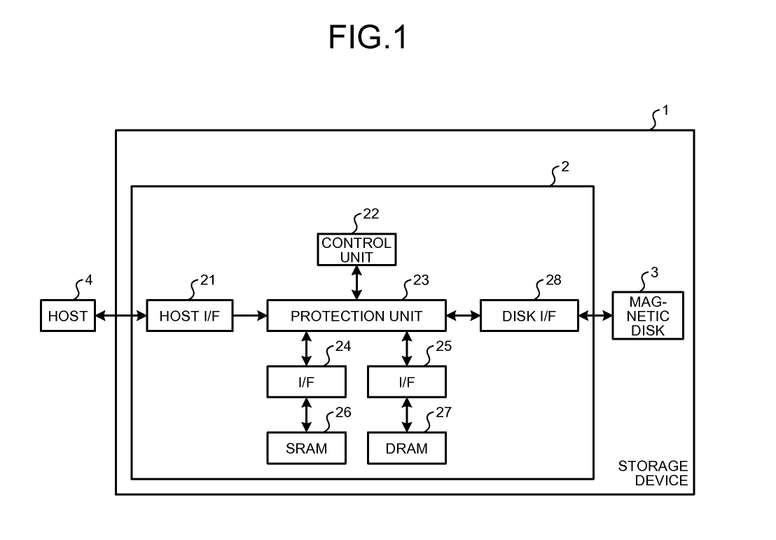

FIG. 1 is a block diagram of a configuration example of a storage device according to a first embodiment. A storage device 1 of this embodiment includes a controller 2 and a magnetic disk 3 as illustrated in FIG. 1. The storage device 1 may be connected to a host 4; a state in which this is connected to the host 4 is illustrated in FIG. 1. The host 4 is an electronic device such as a personal computer and a portable terminal, for example.

Meanwhile, although the example in which the magnetic disk 3 is used as a storage medium is herein described, a semiconductor memory such as a NAND memory may also be used as the storage medium; the storage medium provided on the storage device 1 is not limited to the magnetic disk 3. An SRAM 26 and a DRAM 27 may also be externally connected to the controller 2.

The controller 2 controls writing to the magnetic disk 3 according to a write command from the host 4. The controller 2 also controls reading from the magnetic disk 3 according to a read command from the host 4. The controller 2 includes a host I/F 21, a control unit 22, a protection unit 23, an I/F 24, an I/F 25, the SRAM 26 (first storage unit), the DRAM 27 (second storage unit), and a disk I/F 28.

The controller 2 stores data received from the host 4 in the SRAM 26 through the I/F 24. This also stores the data read from the SRAM 26 through the I/F 24 in the DRAM 27 through the I/F 25. This also stores the data read from the DRAM 27 through the I/F 25 in the magnetic disk 3 through the disk I/F 28.

The data transmitted from the host 4, the data stored in the SRAM 26, the data stored in the DRAM 27, and the data stored in the magnetic disk 3 are coded for data protection. In general, trends and properties of errors occurring in a communication path from the host 4, the SRAM 26, the DRAM 27, and the magnetic disk 3 are different from one another. Therefore, when the data is moved, a data protection system (unit of coding and generator polynomial) might be changed along the way.

For example, suppose that the data stored in the DRAM 27 is coded by a first protection system and the data stored in the magnetic disk 3 is coded by a second protection system. In this case, when the controller 2 reads the data from the DRAM 27 and stores the same in the magnetic disk 3, the protection system is changed from the first protection system to the second protection system along the way. When the protection system is changed along the way in this manner, it is desirable that a section protected by the first protection system and a section protected by the second protection system are overlapped with each other such that there is no section (area) which is not protected.

In order to overlap the first protection system with the second protection system, there might be a method of making a data path of the first protection system and the data path of the second protection system independent from each other. For example, the data path is branched into a first path in which decoding and an error check by the first protection system are performed and a second path in which coding by the second protection system is performed at a branching point. The data passing through the second path is coded by the second protection system to be stored in the magnetic disk 3. When the data includes an error at the branching point, the error is detected by the decoding and the error check by the first protection system of the data passing through the first path.

However, the error check by the first protection system is performed independently from the coding by the above-described second protection system. Therefore, the error of the data passing through the second path is not detected until the data is read from the magnetic disk 3 to be decoded. When the error is detected early, it is possible to reduce the error included in the data stored in the magnetic disk 3 by providing a transmission of the data and the like again; however, the error cannot be detected until the data is read from the magnetic disk 3 to be decoded by this system.

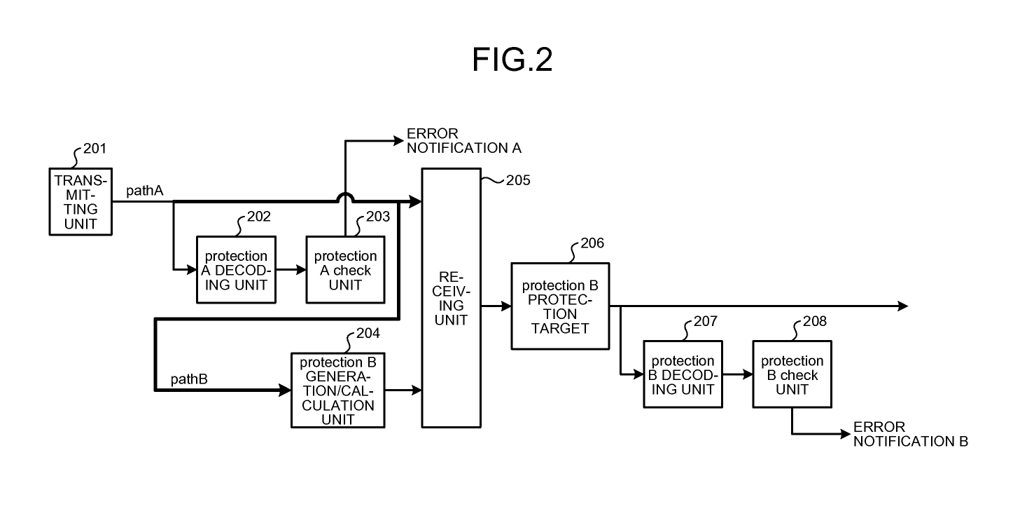

When circuit synthesis is performed, the first path and the second path might be unified. FIG. 2 is a view of a configuration example of a controller of a comparative example in which the circuit synthesis is performed. As a result of the circuit synthesis, suppose that a path A being a data path from a transmitting unit 201 is branched at a first branching point and one of branched paths is input to a protection A decoding unit 202 which decodes by the first protection system and a protection A check unit 203, for example. Suppose that the path A branched at the first branching point is further branched at a second branching point; one of the data paths is the path stored in a protection B protection target unit 206 (for example, the magnetic disk 3) through a receiving unit 205 and the other data path is the path input to a protection B generation/calculation unit 204 which codes by the second protection system. Suppose that a redundant bit generated by the coding by the second protection system is stored in the magnetic disk 3. The data and the redundant bit stored in the protection B protection target unit 206 are input to a protection B decoding unit 207 and a protection B check unit 208 when they are read from the protection B protection target unit 206 and error detection/correction on which is performed. In such a case, sections indicated by bold lines in the drawing, that is to say, the section from branching at the first branching point to storage in the magnetic disk 3 and the section from branching at the second branching point to input to the circuit which codes by the second protection system are not protected.

In this embodiment, as described hereinafter, when the protection system is changed in the middle of the data path, the generator polynomial is set such that the generator polynomial used in the protection system before the change and the generator polynomial used in the protection system after the change have a common factor. Therefore, it is possible to eliminate the section which is not protected which might be generated as a result of the circuit synthesis and to rapidly detect the error included in the data input to the circuit which codes after the change.

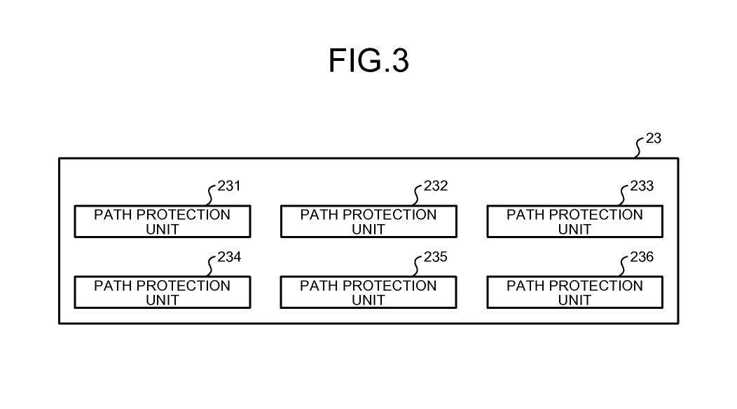

A protection method of this embodiment is hereinafter described. FIG. 3 is a view of a configuration example of a protection unit 23. As illustrated in FIG. 3, the protection unit 23 is provided with path protection units 231 to 236. The path protection unit 231 protects the data from the error occurring from transmission from the host 4 to storage in the SRAM 26 and during the storage in the SRAM 26. The path protection unit 232 protects the data from the error occurring from reading from the SRAM 26 to storage in the DRAM 27 and during the storage in the DRAM 27. The path protection unit 233 protects the data from the error occurring from reading from the DRAM 27 to storage in the magnetic disk 3 and during the storage in the magnetic disk 3.

The path protection unit 234 protects the data from the error occurring from reading from the magnetic disk 3 to the storage in the DRAM 27 and during the storage in the DRAM 27. The path protection unit 235 protects the data from the error occurring from the reading from the DRAM 27 to the storage in the SRAM 26 and during the storage in the SRAM 26. The path protection unit 236 protects the data from the error occurring from the reading from the SRAM 26 to reception by the host 4.

Meanwhile, as described above, the path protection units 231 to 236 are provided for data paths among which the protection system might be changed. The path protection units 231 to 236 are exemplary only and the path protection unit may be provided depending on an actually set data path. For example, when the data read from the magnetic disk 3 is transmitted to the host 4 not through the SRAM 26 and the DRAM 27, the path protection unit for protecting the data from the error occurring from the reading from the magnetic disk 3 to the reception by the host 4 is provided in place of the above-described path protection units 234 to 236.

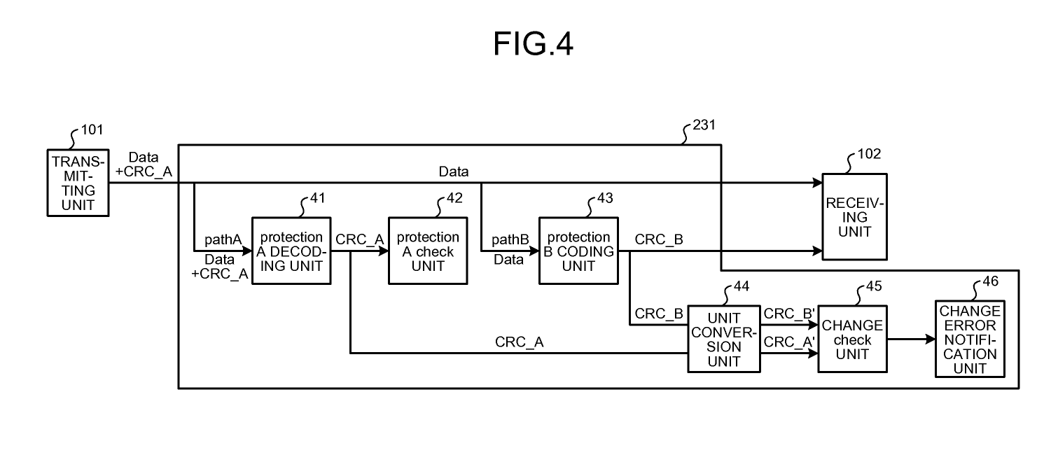

FIG. 4 is a view of a configuration example of the path protection unit 231 of this embodiment. As illustrated in FIG. 4, the path protection unit 231 of this embodiment is provided with a protection A decoding unit 41, a protection A check unit 42, a protection B coding unit (coding unit) 43, a unit conversion unit 44, a change check unit (error check unit) 45, and a change error notification unit 46. A transmitting unit 101 in FIG. 4 is a source from which the data and the protection A are input and the transmitting unit 101 (receiving unit) is the host I/F 21 in the case of the path protection unit 231. A receiving unit 102 is a destination to which the data and the protection B are output and this is the I/F 24 in the case of the path protection unit 231. The path protection units 232 to 236 also have a configuration similar to that of the path protection unit 231. However, the protection system (unit of coding and generator polynomial) is different according to the data path, so that specific circuit configurations of the protection A decoding unit 41, the protection A check unit 42, the protection B coding unit 43, and the unit conversion unit 44 might differ among the path protection units 231 to 236.

The generator polynomial of this embodiment is herein described. In this embodiment, an error detection coding or error correction coding process is performed in order to protect the data. In this embodiment, the coding (error detection coding or error correction coding process) is the coding to perform remainder operation by using the generator polynomial. A code to perform the remainder operation by using the generator polynomial in the coding in this manner includes a cyclic redundancy check (CRC) code, a Bose, Chandhuri, Hocquenghem (BCH) code, a Reed-Solomon (RS) code and the like, for example. It is possible to apply the protection method of this embodiment when these codes are used. FIG. 4 illustrates an example in which the CRC code is used and the redundant bit (redundant bit sequence) of the protection A is represented as CRC_A and the redundant bit of the protection B is represented as CRC_B; however, the code to which this embodiment may be applied is not limited to the CRC code.

The generator polynomial used in the coding of the protection A is represented as G_{A}(x) and the generator polynomial used in the coding of the protection B is represented as G_{B}(x). Polynomial expressions of code words generated by coding the same data (information bit) by the coding of the protection A and the coding of the protection B are C_{A}(x) and C_{B}(x), respectively. The polynomial equations corresponding to the information bits in C_{A}(x) and C_{B}(x) are set to P_{A}(x) and P_{B}(x), respectively, and the polynomial equations corresponding to the redundant bits in C_{A}(x) and C_{B}(x) are set to R_{A}(x) and R_{B}(x), respectively. Herein, C_{A}(x) and C_{B}(x) may be represented by following equations (1) and (2), respectively.

C_{A}(x)=P_{A}(x)+R_{A}(x) (1)

C_{B}(x)=P_{B}(x)+R_{B}(x) (2)

In this embodiment, the generator polynomial G_{B}(x) of the protection B is generated to have the common factor with the generator polynomial G_{A}(x) of the protection A. If the common factor is set to G₀(x), G_{A}(x) and G_{B}(x) may be represented by following equations (3) and (4), respectively. Meanwhile, g_{A}(x) is a product obtained by dividing G_{A}(x) by G₀(x) and g_{A}(x) is a product obtained by dividing G_{B}(x) by G₀(x).

G_{A}(x)=g_{A}(x)G₀(x) (3)

G_{B}(x)=g_{B}(x)G₀(x) (4)

Therefore, following equations (5) and (6) are true.

C_{A}(x)=P_{A}(x)+R_{A}(x)=g_{A}(x)G₀(x)Q_{A}(x) (5)

C_{B}(x)=P_{B}(x)+R_{B}(x)=g_{B}(x)G₀(x)Q_{B}(x) (6)

Meanwhile, Q_{A}(x) and Q_{B}(x) are products obtained by dividing P_{A}(x) and P_{B}(x) by G_{A}(x) and G_{B}(x), respectively.

G_{A}(x) is of higher degree than G_{B}(x) and difference between the degree of G_{A}(x) and that of G_{B}(x) is set to m. Since the information bit of C_{A}(x) is the same as that of C_{B}(x), P_{A}(x) is obtained by shifting P_{B}(x) by m-th degree and following equation (7) is true.

P_{A}(x)=x^{m}P_{B}(x) (7)

Following equation (8) is obtained from equations (5), (6), and (7) described above.

R_{A}(x)+x^{m}R_{B}(x)=(g_{A}(x)Q_{A}(x)+x^{m}g_{B}(x)Q_{B}(x))G₀(x) (8)

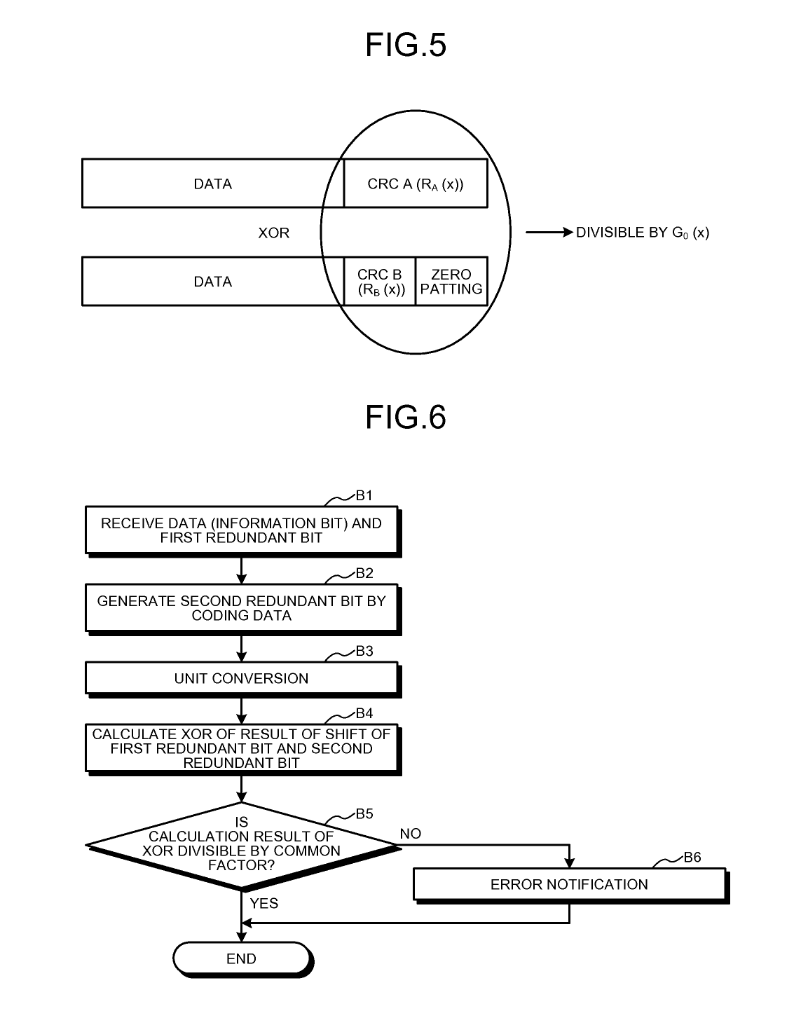

From equation (8) described above, a sum (XOR) of a result of shifting R_{B}(x) by m bits and R_{A}(x) is divisible by G₀(x). FIG. 5 is a view of the XOR of the result of shifting R_{B}(x) by m bits and R_{A}(x). An upper stage in FIG. 5 represents C_{A}(x) and a lower stage represents a result of shifting C_{B}(x) by m bits (performing zero padding). In this manner, the information bits conform to each other by shifting by m bits and the XOR of R_{B}(x) shifted by m bits and R_{A}(x) is divisible by G₀(x). When the sum (XOR) of the result of shifting R_{B}(x) by m bits and R_{A}(x) is not divisible by G₀(x), it is considered that the data input to the coding of the protection A and the data input to the coding of the protection B are different from each other. In this embodiment, difference between the data input to the protection A decoding unit and the data input to the coding of the protection B which should essentially be the same is detected by using this property.

If an information bit length in one code word of the protection A is identical to that of the protection B, it is possible to determine whether there is the error only by dividing the sum (XOR) of the result of shifting R_{B}(x) by m bits and R_{A}(x) by G₀(x). On the other hand, when the information bit length in one code word of the protection A is different from that of the protection B, a unit conversion process to be described later is performed for making the data being targets from which the error is detected conform to each other.

Next, an example of a specific process of the path protection units 231 to 236 is described. In the path protection unit 231, the coding applied to the data transmitted from the host 4 is the protection A and the coding performed when this is stored in the SRAM 26 is the protection B. In this case, the coding of the protection A is performed by the host 4. Therefore, the generator polynomial used by the host 4 in the coding is grasped and the generator polynomial of the coding performed when the data is stored in the SRAM 26 is such that this has the common factor with the generator polynomial.

In the path protection unit 232, the coding applied to the data stored in the SRAM 26 is the protection A and the coding performed when this is stored in the DRAM 27 is the protection B. In the path protection unit 233, the coding applied to the data stored in the DRAM 27 is the protection A and the coding performed when this is stored in the magnetic disk 3 is the protection B.

In the path protection unit 234, the coding applied to the data stored in the magnetic disk 3 is the protection A and the coding performed when this is stored in the DRAM 27 is the protection B. In the path protection unit 235, the coding applied to the data stored in the DRAM 27 is the protection A and the coding performed when this is stored in the SRAM 26 is the protection B. In the path protection unit 236, the coding applied to the data stored in the SRAM 26 is the protection A and the coding performed when this is transmitted to the host 4 is the protection B.

FIG. 6 is a flowchart of an example of a procedure by the path protection unit 231 of this embodiment. Herein, the redundant bit generated based on the protection A is referred to as a first redundant bit and the redundant bit generated based on the protection B is referred to as a second redundant bit. The generator polynomial used in the protection A is referred to as a first generator polynomial and the generator polynomial used in the protection B is referred to as a second generator polynomial. In addition, a case in which the first redundant bit is shorter than the second redundant bit is described. Although an operational example of the path protection unit 231 is described in the following description, the operation of the path protection units 232 to 236 is similar to the operation of the path protection unit 231 except that the source from which the data is input (received) and the destination to which the data is output (transmitted) are different.

First, the path protection unit 231 receives the data (information bit) and the first redundant bit generated by using the first generator polynomial from the host I/F 21 (block B1). The protection A decoding unit 41 decodes by using the data and the first redundant bit and inputs the first redundant bit to the unit conversion unit 44 and the protection A check unit 42. Herein, decoding is calculating to obtain a remainder of the data and the redundant bit by using the first generator polynomial; in a state in which only the data is input, the same result as that when the coding of the data is performed by using the first generator polynomial is obtained when the data includes no error. The protection B coding unit 43 codes the data by using the second generator polynomial to generate the second redundant bit (block B2).

The unit conversion unit 44 performs the unit conversion process to be described later by using the second redundant bit and the first redundant bit (block B3). The change check unit 45 calculates an XOR of a result of shifting the first redundant bit after unit conversion and the second redundant bit after the unit conversion (block B4). The change check unit 45 determines whether an XOR calculation result is divisible by the common factor (block B5) and finishes the process when this is divisible (Yes at block B5). When this is not divisible (No at block B5), the change error notification unit 46 which is notified of a result notifies the control unit 22 of the error (block B6) and finishes the process.

Next, the unit conversion process of this embodiment is described. For example, suppose that a bus width is eight bits and eight information bits are transferred by one transfer. Suppose that one redundant bit R_{A}(x) is generated for eight information bits in the protection A, and 32 redundant bits R_{B}(x) are generated for 512 information bits in the protection B. In this case, the information bit length of the protection target per one code word of the protection A is different from that of the protection B and it is not possible to directly detect the error by using equation (8) described above. Therefore, as described hereinafter, the unit conversion to make the information bit length of the protection B conform to that of the protection target per one code word of the protection A is performed. Herein, suppose that the information bit length of the protection target per one code word of the protection A conforms to the bus width. Therefore, the redundant bit after the unit conversion is generated in one transfer unit. Dᵢ is the data (eight-bit) of an i-th bus transfer and Dᵢ(x) is polynomial expression of Dᵢ. At that time, when R_{B,1}(x) is the redundant bit generated at the time of the coding of D₁(x) by the second generator polynomial G_{B}(x), following equation (9) is true.

D₁(x)+R_{B,1}(x)=G_{B}(x)Q_{B,1}(x) (9)

Meanwhile, Q_{B,i}(x) is a product obtained when Dᵢ(x) is divided by G_{B}(x).

As represented by equation (9), the redundant bit R_{B,1}(x) calculated by dividing D₁(x) by G_{B}(x) is calculated in a first transfer. Therefore, the protection target of the protection B conforms to the protection target of the protection A, so that it is possible to use R_{B,1}(x) as R_{B}(x) in equation (8) described above.

Next, D₂(x) is made the data (eight-bit) of a second bus transfer and R_{B,2}(x) is made the redundant bit generated by using G_{B}(x) for D₁(x) and D₂(x). The code word generated at that time is divisible by G_{B}(x). Therefore, equation (10) is true.

x⁸D₁(x)+D₂(x)+R_{B,2}(x)=G_{B}(x)Q_{B,2}(x) (10)

Following equation (11) is obtained by deleting Dᵢ(x) from equations (9) and (10).

D₂(x)+x⁸R_{B,1}(x)+R_{B,2}(x)=(x⁸Q_{B,1}(x)+Q_{B,2}(x))G_{B}(x) (11)

Therefore, a left side of equation (11) is divisible by G_{B}(x). A first term of the left side is the information bit of the second transfer and conforms to the protection target of the protection A. Although a second term of the left side is 40 (=32+8) bits since 32 redundant bits are shifted by eight bits, a result the same as that obtained by dividing this term by G_{B}(x) is obtained by properties of the Galois field and the generator polynomial. Therefore, the second term of the left side is a remainder obtained by dividing a result of shifting the redundant bit R_{B,1}(x) generated in a previous transfer by eight bits by G_{B}(x). That is to say, this is a result of coding the result of shifting R_{B,1}(x) by eight bits by using G_{B}(x). Therefore, a redundant bit R′_{B,2}(x) of the protection B corresponding to D₂(x) of the second transfer is an XOR of the result of coding the result of shifting the redundant bit R_{B,1}(x) generated at the time of the previous transfer by eight bits by using G_{B}(x) and the redundant bit R_{B,2}(x) generated in the second transfer.

In third and subsequent transfers, if the number of transfers is set to i, following equations (12) and (13) are true for an (i−1)-th transfer and an i-th transfer, respectively.

x⁸⁽ⁱ⁻²⁾D₁(x)=x⁸Dᵢ₋₂(x)+Dᵢ₋₁(x)+R_{B,i-1}(x)=G_{B}(x)Q_{B,i-1}(x) (12)

x⁸⁽ⁱ⁻¹⁾D₁(x)+x⁸Dᵢ₋₁(x)+Dᵢ(x)+R_{B,i}(x)=G_{B}(x)Q_{B,i}(x) (13)

Following equation (14) is true from equations (12) and (13).

Dᵢ(x)+x⁸R_{B,i-1}(x)+R_{B,i}(x)=(x⁸Q_{B,i-1}(x)+Q_{B,i}(x))G_{B}(x) (14)

Therefore, a redundant bit R′_{B,i}(x) of the protection B corresponding to Dᵢ(x) input at the time of the i-th transfer is an XOR of a result of coding a result of shifting a redundant bit R_{B,i-1}(x) generated at the time of the previous transfer by eight bits by using G_{B}(x) and a redundant bit R_{B,i}(x) generated in the i-th transfer.

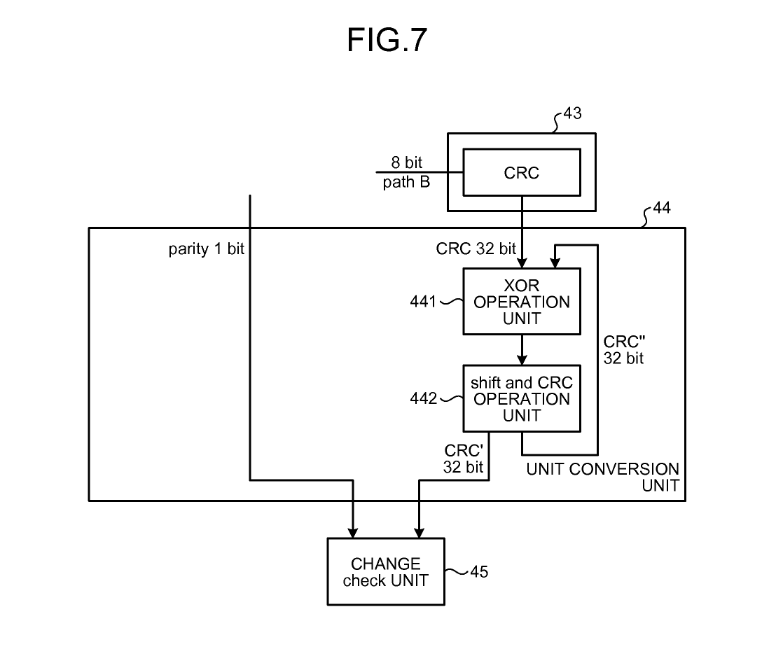

A configuration example of the unit conversion unit 44 for realizing the above-described unit conversion is described. FIG. 7 is a view of the configuration example of the unit conversion unit 44. In the example in FIG. 7, the bus width is set to eight bits; one-bit parity is generated as the redundant bit R_{A}(x) for the eight information bits in the protection A and CRC (32-bit) is generated as the redundant bit R_{B}(x) for 512 information bits in the protection B.

As illustrated in FIG. 7, the unit conversion unit 44 is provided with an XOR operation unit 441 and a shift and CRC operation unit 442. The one-bit parity of the protection A is directly input to the change check unit 45.

Regarding the protection B, the protection B coding unit 43 outputs an intermediate operation result of CRC being the redundant bit for each input of the eight information bits. That is to say, the protection B coding unit 43 outputs the redundant bit obtained by coding eight-bit D₁(x) by using G_{B}(x) to the unit conversion unit 44 in the first transfer. The protection B coding unit 43 outputs the redundant bit obtained by coding eight-bit D₁(x) and D₂(x) by using G_{B}(x) to the unit conversion unit 44 in the second transfer. The protection B coding unit 43 outputs the redundant bit (CRC in this example) obtained by coding eight-bit D₁(x), D₂(x), . . . , and Dᵢ(x) by using G_{B}(x) to the unit conversion unit 44 in the third and subsequent transfers. Then, in a 64-th transfer, the protection B coding unit 43 outputs the redundant bit obtained by coding eight-bit D₁(x), D₂(x), . . . , and D₆₄(x) by using G_{B}(x) to the unit conversion unit 44 and outputs the redundant bit to the output destination (for example, the I/F 24) as a final redundant bit for 512 bits.

The XOR operation unit 441 outputs a result of calculating an XOR of CRC input from the protection B coding unit 43 and CRC″ to be described later input from the shift and CRC operation unit 442 to the change check unit 45 as CRC′ and outputs CRC to the shift and CRC operation unit 442. Meanwhile, although an example in which the XOR operation unit 441 outputs CRC′ to the change check unit 45 through the shift and CRC operation unit 442 is illustrated in FIG. 7, CRC′ may be directly output to the change check unit 45. The shift and CRC operation unit 442 shifts CRC by eight bits, performs coding operation of shifted CRC by using G_{B}(x) (in this case, CRC operation), and inputs an operation result to the XOR operation unit 441 as CRC″. CRC″ corresponds to a second term (x⁸R_{B,i-1}(x)) in equation (14). Meanwhile, although the example in which the one parity bit is generated as the protection A and the CRC code is used as the protection B is illustrated in FIG. 7, the protection system of the protection A and protection B is not limited thereto. When using other than the CRC code, the shift and CRC operation unit 442 may perform the same coding as the coding by the protection B coding unit 43 after the shift. Although the bus width is herein set to eight bits, the bus width is not limited to eight bits. When the bus width is identical to the number of information bits of the unit of coding in the protection A, it is possible to realize the unit conversion with the configuration similar to that in FIG. 7 even when the bus width is not eight bits. The shift and CRC operation unit 442 may shift by the bus width.

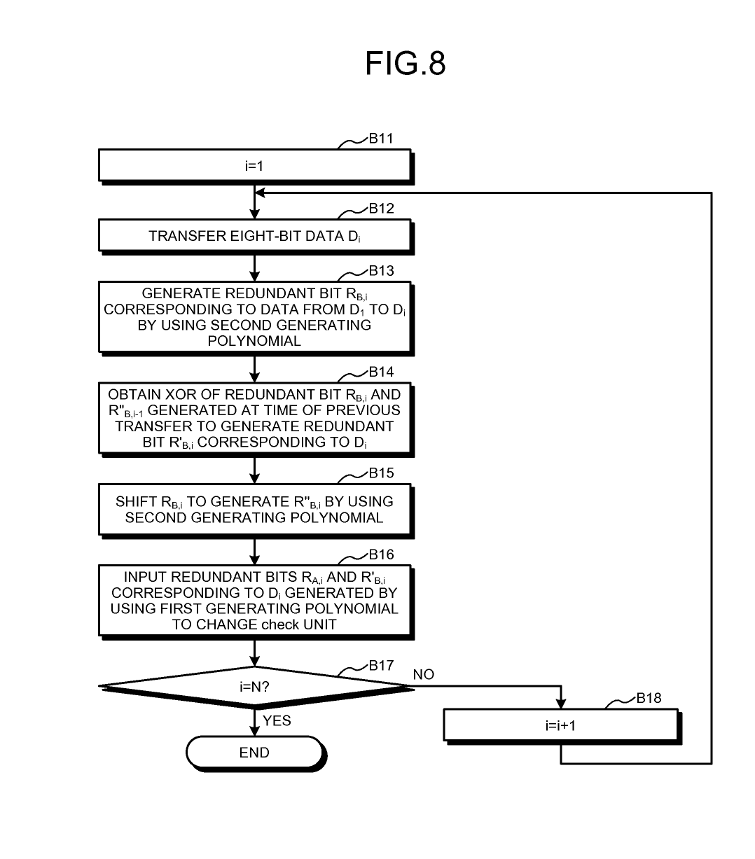

FIG. 8 is a view of an example of a unit conversion procedure when the unit conversion unit 44 of the configuration example in FIG. 7 is used. First, the protection B coding unit 43 sets i=1 (block B11). Eight-bit data Dᵢ is transferred to the protection B coding unit 43 (block B12). The protection B coding unit 43 generates a redundant bit R_{B,i} corresponding to the data (information bit) from D₁ to Dᵢ by using the second generator polynomial G_{B}(x) (block B13). The XOR operation unit 441 of the unit conversion unit 44 obtains an XOR of R_{B,i} and R″_{B,i-1} (=x⁸R_{B,i-1}) generated in the previous transfer to generate the redundant bit R′_{B,i} corresponding to Dᵢ (block B14).

The shift and CRC operation unit 442 shifts R_{B,i}, codes a shifted result by using the second generator polynomial G_{B}(x) to generate R″_{B,i}, and inputs the same to the XOR operation unit 441 (block B15). This R″_{B,j}, is used as R″_{B,i-1} generated at the time of the previous transfer at block B14 in a next transfer.

Then, the unit conversion unit 44 inputs a redundant bit R_{A,i} corresponding to Dᵢ generated by using the first generator polynomial G_{A}(x) and R′_{B,i} generated at block B14 to the change check unit 45 (block B16). The protection B coding unit 43 determines whether i=N (block B17). N is a numeral value obtained by dividing a redundant bit length of the unit of coding of the protection B by the bus width. If i=N is not satisfied (No at block B17), it is set that i=i+1 (block B18) and the procedure returns to Block B12. If i=N is satisfied (Yes at block B17), the protection B coding unit 43 outputs R_{B,N} to the receiving unit 102 being the output destination and finishes the process. According to this, the unit conversion of one code word of the protection B is finished.

The change check unit 45 calculates a left side of equation (8) described above by using R_{A,i} and R′_{B,i} as R_{A} and R_{B}, respectively, and determines whether there is the error based on whether a calculation result is divisible by G₀(x).

Meanwhile, when the information bit length in the unit of coding is the same in the protection A and protection B, the path protection units 231 to 236 are not required to be provided with the unit conversion unit 44. When the information bit length in the unit of coding of the protection B is shorter than that of the protection A, the XOR operation unit 441 and the shift and CRC operation unit 442 may be provided not on the protection B side but on the protection A side.

As described above, in this embodiment, when the protection system to the data is changed from the protection A to the protection B, the generator polynomial is set such that the generator polynomial used in the protection A and the generator polynomial used in the protection B have the common factor. Therefore, it is possible to eliminate the section which is not protected and rapidly detect the error included in the data input to the circuit which codes after the change. It is configured such that the unit conversion process to generate the redundant bit in the unit conforming to the information bit of the protection target of the protection A is performed when the information bit length in the unit of coding of the protection A is different from that of the protection B. Therefore, the above-described effect may be obtained even when the information bit length in the unit of coding of the protection A is different from that of the protection B.

### Second Embodiment

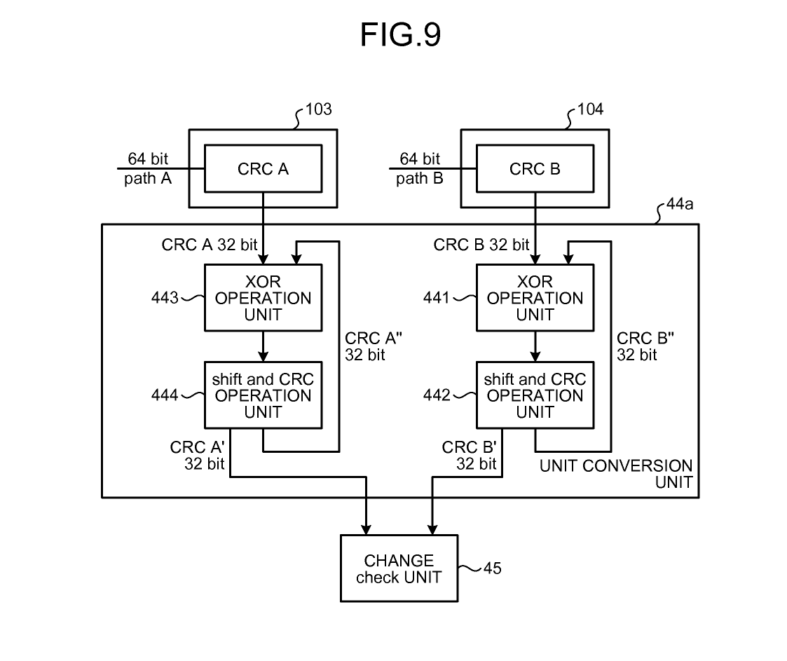

FIG. 9 is a block diagram of a configuration example of a unit conversion unit 44a in a storage device according to a second embodiment. The storage device of this embodiment is similar to a storage device 1 of a first embodiment except that a unit conversion unit 44 of each of path protection units 231 to 236 is replaced with a unit conversion unit 44a. Difference from the first embodiment is hereinafter described.

Unit conversion in a case in which a bus width is identical to an information bit length of a unit of coding of protection A is described in the first embodiment. An example in which the information bit lengths of the units of coding of both protection A and protection B are different from the bus width is described in this embodiment.

As illustrated in FIG. 9, the unit conversion unit 44a is provided with XOR operation units 441 and 443 and shift and CRC operation units 442 and 444. The XOR operation unit 441 and the shift and CRC operation unit 442 are similar to the XOR operation unit 441 and the shift and CRC operation unit 442 of the first embodiment. However, an example in which the bus width is 64 bits different from that of the first embodiment is described in the example in FIG. 9. Meanwhile, the bus width is not limited to that in the example in FIG. 9.

Although an example in which a redundant bit is already generated for the protection A is described in the first embodiment, not a final redundant bit but an intermediate calculation result of the redundant bit for each transfer by the bus width is used in this embodiment. A protection A coding unit 103 (input side coding unit) and a protection B coding unit 104 in FIG. 9 are a protection A decoding unit 41 and a protection B coding unit 43 in FIG. 4, respectively.

Next, a unit conversion process of this embodiment is described. The XOR operation unit 443 and the shift and CRC operation unit 444 perform processes similar to those of the XOR operation unit 441 and the shift and CRC operation unit 442 on the redundant bit of the protection A. D₁ is data (64-bit) received by an i-th transfer. Regarding the protection B, following equation (15) is true when generalizing the bus width to w bits in equation (14) described in the first embodiment.

Dᵢ(x)+x^{w}R_{B,i-1}(x)+R_{B,i}(x)=(x^{w}Q_{B,i-1}(x)+Q_{B,i}(x))G_{B}(x) (15)

Following equation (16) is similarly true also regarding the protection A. R_{A,i}(x) is an intermediate result of the redundant bit generated by the protection A coding unit 103 at the time of the i-th transfer.

Dᵢ(x)+x^{w}R_{A,i-1}(x)+R_{A,i}(x)=(x^{w}Q_{A,i-1}(x)+Q_{A,i}(x))G_{A}(x) (16)

Therefore, regarding the protection A also, a redundant bit R′_{A,i}(x) of the protection A corresponding to Dᵢ(x) input at the time of the i-th transfer may be obtained as an XOR of a result of coding a result of shifting a redundant bit R_{A,i-1}(x) generated at the time of a previous transfer by w bits by using G_{A}(x) and the redundant bit R_{A,i}(x) generated in the i-th transfer. Therefore, as illustrated in FIG. 9, the unit conversion unit 44a is provided with a configuration similar to that of the protection B in the first embodiment regarding the protection A also. The change check unit 45 calculates a left side of equation (8) described above by using R′_{A,i} and R′_{B,i} as R_{A} and R_{B}, respectively, and determines whether there is an error based on whether a calculation result is divisible by G₀(x).

Although an example in which the bus width is the same in the protection A and the protection B is herein described, a check by the change check unit 45 may be applied also when the bus width of the protection A is different from that of the protection B. In this case, the configuration of the unit conversion unit is similar to that of the unit conversion unit 44a in FIG. 9. When the bus width of the protection A is different from that of the protection B, it is checked in accordance with a larger bus width. For example, suppose that the bus width in the protection A is 16 bits and that in the protection B is eight bits. In this case, 16-bit data is made a unit of check and the protection B coding unit 104 may output the intermediate result of the redundant bit to the unit conversion unit 44a for each two transfers of the data.

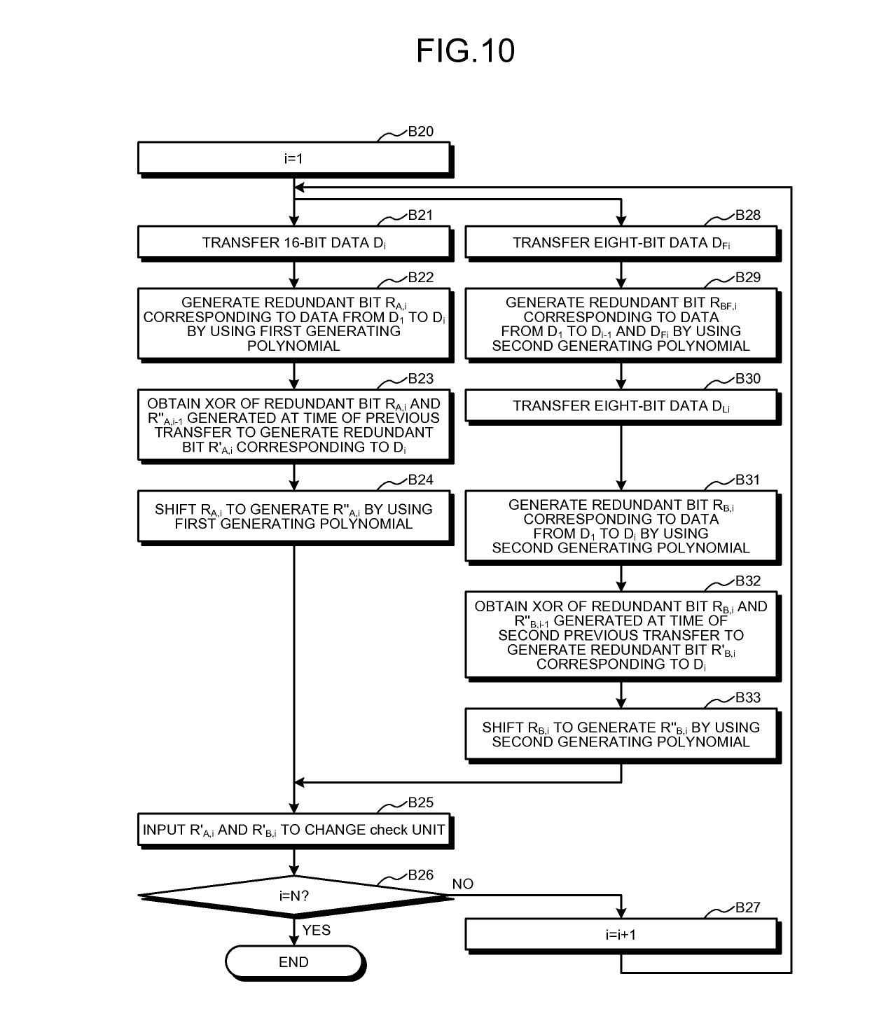

FIG. 10 is a view of an example of a unit conversion procedure when the bus width of the protection A is different from that of the protection B. First, the protection A coding unit 103 and the protection B coding unit 104 set i=1 (block B20). Meanwhile, i is a variable incremented for each transfer in the protection A coding unit 103 and incremented for each two transfers in the protection B coding unit 104. To the protection A coding unit 103, 16-bit data Dᵢ is transferred (block B21). A redundant bit R_{A,i} corresponding to the data (information bit) from D₁ to Dᵢ is generated by using a first generator polynomial G_{A}(x) (block B22). The XOR operation unit 443 of the unit conversion unit 44a obtains an XOR of R_{A,i} and R″_{A,i-1} generated at the time of the previous transfer to generate a redundant bit R′_{A,i} corresponding to Dᵢ (block B23). The shift and CRC operation unit 444 shifts R_{A,i}, codes a shifted result by using the first generator polynomial G_{A}(x) to generate R″_{A,i}, and inputs the same to the XOR operation unit 443 (block B24). The unit conversion unit 44a inputs R′_{A,i} and R′_{B,i} to be described later to the change check unit 45 (block B25).

On the other hand, eight-bit data D_{Fi} is transferred to the protection B coding unit 104 (block B28). Herein, the data obtained by dividing 16-bit Dᵢ into two are D_{Fi} and D_{Li}. The protection B coding unit 104 generates a redundant bit R_{BF,i} corresponding to the data (information bit) from D₁ to Dᵢ₋₁ and D_{Fi} by using a second generator polynomial G_{B}(x) (block B29). Then, next eight-bit data D_{Li} is transferred to the protection B coding unit 104 (block B30). The protection B coding unit 104 generates a redundant bit R_{B,i} corresponding to the data (information bit) from D₁ to Dᵢ by using the second generator polynomial G_{B}(x) to output to the unit conversion unit 44a (block B31). The XOR operation unit 441 of the unit conversion unit 44a obtains an XOR of R_{B,i} and R″_{B,i-1} generated at the time of a second previous transfer to generate a redundant bit R′_{B,i} corresponding to Dᵢ (block B32). The shift and CRC operation unit 442 shifts R_{B,i}, codes a shifted result by using the second generator polynomial G_{B}(x) to generate R″_{B,i}, and inputs the same to the XOR operation unit 441 (block B33).

After block B25, the protection A coding unit 103 and the protection B coding unit 104 determines whether i=N is satisfied (block B26). Meanwhile, N is a value obtained by dividing a least common multiple of code word lengths of the protection A and the protection B by the bus width, for example. If i=N is not satisfied (No at block B26), it is set that i=i+1 (block B27) and the procedure returns to blocks B21 and B28. When i=N is satisfied (Yes at block B26), the procedure is finished.

The unit conversion process when the unit of coding of the protection A is different from the bus width and when the bus width of the protection A is different from that of the protection B is described above in this embodiment. According to this, the effect similar to that of the first embodiment may be obtained also when the unit of coding of the protection A is different from the bus width and when the bus width of the protection A is different from that of the protection B.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A controller comprising:
a receiving unit configured to receive data and a first redundant bit generated by coding the data by using a first generator polynomial;
a coding unit configured to code the data by a second generator polynomial having a common factor with the first generator polynomial to generate a second redundant bit; and
an error check unit configured to determine whether there is difference between the data input to coding by using the first generator polynomial and the data input to coding by using the second generator polynomial by dividing an XOR operation result of the received first redundant bit and a result of a bit shift of the second redundant bit by the common factor.

2. The controller of claim 1 further comprising:
a unit conversion unit configured to, when a size of the data from which the first redundant bit is generated and a size of the data from which the second redundant bit is generated are different from each other, perform a unit conversion process for at least one of the first redundant bit and the second redundant bit, the unit conversion process being a process to make the sizes of the data being protection targets of the first redundant bit and the second redundant bit conform to each other, wherein
the controller inputs the first redundant bit and the second redundant bit after the unit conversion process by the unit conversion unit to the error check unit.

3. The controller of claim 2, wherein the coding unit inputs an intermediate result of the second redundant bit generated by the same coding as the coding of the second redundant bit to the unit conversion unit each time the data of a certain size smaller than the size of the data from which the second redundant bit is generated is input, and
the unit conversion unit generates an XOR result of the input intermediate result and a result of coding, by using the second generator polynomial, a result of a bit shift of a previous intermediate result input from the coding unit as the second redundant bit after the unit conversion process.

4. The controller of claim 2 further comprising:
an input side coding unit configured to code the data by using the first generator polynomial to generate the first redundant bit and input an intermediate result of the first redundant bit generated by the same coding as the coding of the first redundant bit to the unit conversion unit each time the data of the certain size smaller than the size of the data from which the first redundant bit is generated is input, wherein
the unit conversion unit generates an XOR result of the input intermediate result and a result of coding, by using the second generator polynomial, a result of a bit shift of a previous intermediate result input from the input side coding unit as the first redundant bit after the unit conversion process.

5. The controller of claim 1 further comprising:
an I/F for a storage unit, wherein
the controller is configured to
receive the data and the first redundant bit from a host, and
store the second redundant bit and the data in the storage unit through the I/F.

6. The controller of claim 1, is further configured to
control a magnetic disk, and
store the second redundant bit and the data in the magnetic disk.

7. The controller of claim 1 further comprising:
a first I/F and a second I/F for a first storage unit and a second storage unit, respectively, wherein
the controller is configured to
store the first redundant bit and the data in the first storage unit through the first I/F, and
store the second redundant bit and the data in the second storage unit through the second I/F.

8. The controller of claim 1 further comprising:
an error notification unit configured to provide notification of an error when the error check unit determines that there is difference.

9. A storage device comprising:
a storage unit; and
a controller configured to control the storage unit,
the controller including:
a receiving unit configured to receive data and a first redundant bit generated by coding the data by using a first generator polynomial;
a coding unit configured to code the data by a second generator polynomial having a common factor with the first generator polynomial to generate a second redundant bit; and
an error check unit configured to determine whether there is difference between the data input to coding by using the first generator polynomial and the data input to coding by using the second generator polynomial by dividing an XOR operation result of the received first redundant bit and a result of a bit shift of the second redundant bit by the common factor.

10. The storage device of claim 9, wherein
the controller further comprising:
a unit conversion unit configured to, when a size of the data from which the first redundant bit is generated and a size of the data from which the second redundant bit is generated are different from each other, perform a unit conversion process for at least one of the first redundant bit and the second redundant bit, the unit conversion process being a process to make the sizes of the data being protection targets of the first redundant bit and the second redundant bit conform to each other, wherein
the controller inputs the first redundant bit and the second redundant bit after the unit conversion process by the unit conversion unit to the error check unit.

11. The storage device of claim 10, wherein the coding unit inputs an intermediate result of the second redundant bit generated by the same coding as the coding of the second redundant bit to the unit conversion unit each time the data of a certain size smaller than the size of the data from which the second redundant bit is generated is input, and
the unit conversion unit generates an XOR result of the intermediate result and a result of coding a result of a bit shift of a previous intermediate result input from the coding unit by using the second generator polynomial as the second redundant bit after the unit conversion process.

12. The storage device of claim 10, wherein
the controller further comprising
an input side coding unit configured to code the data by using the first generator polynomial to generate the first redundant bit and input an intermediate result of the first redundant bit generated by the same coding as the coding of the first redundant bit to the unit conversion unit each time the data of the certain size smaller than the size of the data from which the first redundant bit is generated is input, wherein
the unit conversion unit configured to generate an XOR result of the intermediate result input from the input side coding unit and a result of coding a result of a bit shift of a previous intermediate result input from the input side coding unit by using the second generator polynomial as the first redundant bit after the unit conversion process.

13. The storage device of claim 9, wherein
the controller further comprising
an I/F for a storage unit,
receives the data and the first redundant bit from a host, and
stores the second redundant bit and the data in the storage unit through the I/F.

14. The storage device of claim 9, wherein the controller controls a magnetic disk, and
stores the second redundant bit and the data in the magnetic disk.

15. The storage device of claim 9, wherein
the controller further comprising
a first I/F and a second I/F for a first storage unit and a second storage unit, respectively,
stores the first redundant bit and the data in the first storage unit through the first I/F, and
stores the second redundant bit and the data in the second storage unit through the second I/F.

16. The storage device of claim 9 further comprising:
an error notification unit configured to provide notification of an error when the error check unit determines that there is difference.

17. A control method of data to be stored comprising:
receiving data and a first redundant bit generated by coding the data by using a first generator polynomial;
coding the data by a second generator polynomial having a common factor with the first generator polynomial to generate a second redundant bit; and
determining whether there is difference between the data input to coding by using the first generator polynomial and the data input to coding by using the second generator polynomial by dividing an XOR operation result of the received first redundant bit and a result of a bit shift of the second redundant bit by the common factor.

18. The control method of claim 17 further comprising:
performing, when a size of the data from which the first redundant bit is generated and a size of the data from which the second redundant bit is generated are different from each other, a unit conversion process for at least one of the first redundant bit and the second redundant bit, the unit conversion process being a process to make the sizes of the data being protection targets of the first redundant bit and the second redundant bit conform to each other; and
providing the first redundant bit and the second redundant bit after the unit conversion process.

19. The control method of claim 18 further comprising:
inputting an intermediate result of the second redundant bit generated by the same coding as the coding of the second redundant bit to the unit conversion process each time the data of a certain size smaller than the size of the data from which the second redundant bit is generated is input in the coding by using the second generator polynomial; and
generating an XOR result, in the unit conversion process, of the intermediate result and a result of coding a result of a bit shift of a input previous intermediate result by using the second generator polynomial as the second redundant bit after the unit conversion process.

20. The control method of claim 18 further comprising:
generating the first redundant bit by coding the data by using the first generator polynomial and inputting an intermediate result of the first redundant bit generated by the same coding as the coding of the first redundant bit to the unit conversion process each time the data of the certain size smaller than the size of the data from which the first redundant bit is generated is input; and
generating an XOR result, in the unit conversion process, of the input intermediate result and a result of coding a result of a bit shift of a previously input intermediate result by using the second generator polynomial as the first redundant bit after the unit conversion process.
